(19) United States
(12) Patent Application Publication
(10) Pub. No.: US 2021/0142117 A1
(43) Pub. Date: May 13, 2021

(54) APPARATUS AND METHOD FOR VERFICATION OF INFORMATION

(71) Applicant: Institute For Information Industry, Taipei (TW)

(72) Inventors: Ping-I CHEN, Taipei (TW); Wen-Nan WANG, Taipei (TW); Wen-Fa HUANG, Taipei (TW); Hsin-Yi KUO, Taipei (TW)

(21) Appl. No.: 16/702,354

(22) Filed: Dec. 3, 2019

(30) Foreign Application Priority Data
Nov. 11, 2019 (TW) 108140846

(51) Int. Cl. G06K 9/62; G06N 5/02; G06N 3/08; G06N 20/00; G06F 40/166

(52) U.S. Cl. CPC G06K 9/6262; G06K 9/6296; G06K 9/6202; G06F 40/166; G06N 5/02; G06N 3/08; G06N 20/00; G06K 9/6256

(57) ABSTRACT

An apparatus and method for verification of information are provided. The apparatus for verification of information includes a storage and a processor, wherein the storage and the processor are electrically connected with each other. The storage stores a reference knowledge graph. The processor generates a to-be-verified knowledge graph of a to-be-verified article by a knowledge graph engine. The processor generates a verified result of the to-be-verified article by comparing the to-be-verified knowledge graph and the reference knowledge graph. The knowledge graph engine may generate the reference knowledge graph by searching and labeling a plurality of related articles according to a plurality of reference articles that have been labeled.

### PRIORITY

This application claims priority to Taiwan Patent Application No. 108140846 filed on Nov. 11, 2019, which is hereby incorporated by reference in its entirety.

### FIELD

The present invention relates to an apparatus and method for verification of information. In particular, the present invention relates to an apparatus and method for verification of information that detect abnormal information by using knowledge graphs.

### BACKGROUND

With the rapid development of the Internet, we have entered an era that everyone can be a self-media publisher (i.e. everyone can publish and disseminate information on the Internet). Due to various benefits, a lot of groups and individuals continuously and deliberately publish and disseminate altered or abnormal information in digital media, trying to influence people's understanding of facts. At present, there are some techniques that use keyword comparison to find abnormal information. However, some abnormal information contains a large number of correct keywords but carries some altered or incorrect information, which cannot be found by using simple keyword comparison. At present, such abnormal information can only be found based on human's inspection or check.

Accordingly, there is still an urgent need for a technology that can correctly and quickly verify abnormal information in digital media.

### SUMMARY

In order to solve the above technical problems and to correctly verify abnormal information in digital media, provided are apparatuses and methods for verification of information.

An apparatus for verification of information may comprise in an example embodiment a storage and a processor, which are electrically connected with each other. The storage stores a reference knowledge graph. The processor generates a to-be-verified knowledge graph of a to-be-verified article by a knowledge graph engine and generates a verified result of the to-be-verified article by comparing the to-be-verified knowledge graph with the reference knowledge graph. The knowledge graph engine may generate the reference knowledge graph by searching and labeling a plurality of related articles according to a plurality of reference articles that have been labeled.

An apparatus for verification of information also may comprise in another example embodiment a storage and a processor, which are electrically connected with each other. The storage stores a reference knowledge graph. The processor generates a to-be-verified knowledge graph of a to-be-verified article by a knowledge graph engine. The processor reduces the dimension of the to-be-verified knowledge graph into a to-be-verified dataset and reduces the dimension of the reference knowledge graph into a reference dataset. The processor generates a verified result of the to-be-verified article by comparing the to-be-verified dataset with the reference dataset.

A method for verification of information is adapted for use in an electronic computing device. The method for verification of information may comprise in an example embodiment: (a) generating a to-be-verified knowledge graph of a to-be-verified article by a knowledge graph engine and (b) generating a verified result of the to-be-verified article by comparing the to-be-verified knowledge graph with a reference knowledge graph. The knowledge graph engine may generate the reference knowledge graph by searching and labeling a plurality of related articles according to a plurality of reference articles that have been labeled.

A method for verification of information can also be adapted for use in an electronic computing apparatus. The method for verification of information may comprise in an example embodiment: (a) generating a to-be-verified knowledge graph of a to-be-verified article by a knowledge graph engine, (b) reducing the dimension of the to-be-verified knowledge graph into a to-be-verified dataset, (c) reducing the dimension of a reference knowledge graph into a reference dataset, and (d) generating a verified result of the to-be-verified article by comparing the to-be-verified dataset with the reference dataset.

The technology (at least including apparatuses and methods) for verification of information utilize technologies related to knowledge graphs to verify whether a to-be-verified article needed to be confirmed (i.e., abnormal information). Since a knowledge graph contains a plurality of keywords and correlation information between the keywords, the technology for verification of information can find out abnormal keywords as well as abnormal correlation information. Thereby, the technology for verification of information does not have the defects that the prior art has.

The detailed technology and preferred embodiments implemented for the subject invention are described in the following paragraphs accompanying the appended drawings for a person having ordinary skill in the art to well appreciate the features of the claimed invention.

### BRIEF DESCRIPTION OF THE DRAWINGS

FIG. 1A depicts a schematic view of an apparatus 1 for verification of information according to a first embodiment;

FIG. 1B depicts a specific example of a reference knowledge graph KG1;

FIG. 1C depicts a specific example of a to-be-verified knowledge graph KG2;

FIG. 1D depicts a specific example of a reference dataset RD1;

FIG. 1E depicts a specific example of a to-be-verified dataset RD2;

FIG. 1F depicts a schematic view of the keywords and correlation information labeled in a reference article 14a;

FIG. 2A depicts a main flowchart of a method for verification of information according to a second embodiment;

FIG. 2B depicts a main flowchart of a method for verification of information according to some embodiments; and

FIG. 2C depicts a flowchart for establishing and updating a reference knowledge graph according to some embodiments.

### DETAILED DESCRIPTION

In the following description, apparatuses and methods for verification of information will be explained with reference to certain example embodiments thereof. However, these example embodiments are not intended to limit the present invention to any environment, applications, examples, embodiments or implementations described in these example embodiments. Therefore, description of these example embodiments is only for purpose of illustration rather than to limit the scope of the present invention.

It should be appreciated that, in the following embodiments and the attached drawings, elements unrelated to the present invention are omitted from depiction. In addition, dimensions of and dimensional scales between individual elements in the attached drawings are provided only for ease of depiction and description, but not to limit the scope of the present invention.

A first embodiment of the present invention is an apparatus 1 for verification of information (hereinafter referred to as “information verification apparatus 1”) and a schematic view of which is depicted in FIG. 1A. The information verification apparatus 1 comprises a storage 11 and a processor 13, which are electrically connected with each other. The storage 11 may be a memory, a hard disk drive (HDD), a universal serial bus (USB) disk, a compact disk (CD), or any other non-transitory storage medium or apparatus with the same function and well-known to a person having ordinary skill in the art. The processor 13 may be one of various processors, central processing units (CPUs), microprocessor units (MPUs), digital signal processors (DSPs), or any other computing apparatuses with the same function and well-known to a person having ordinary skill in the art.

The storage 11 stores a reference knowledge graph KG1, wherein the reference knowledge graph KG1 comprises a plurality of keywords and a plurality of pieces of correlation information between the keywords. In some embodiments, the reference knowledge graph KG1 may be a knowledge graph that is dedicated to a certain field (e.g., news, medical treatment) to improve the accuracy of verification and reduce the complexity of the knowledge graph. In some other embodiments, the reference knowledge graph KG1 may not be limited to a certain field. Please refer to a specific example shown in FIG. 1B for better understanding, which, however, is not intended to limit the scope of the present invention. In the specific example shown in FIG. 1B, the reference knowledge graph KG1 includes five keywords E1, E2, E3, E4, E5 and five pieces of directional correlation information R1, R2, R3, R4, R5, wherein the correlation information R1 is the keyword E1 pointing to the keyword E2, the correlation information R2 is the keyword E1 pointing to the keyword E3, the correlation information R3 is the keyword E2 pointing to the keyword E3, the correlation information R4 is the keyword E1 pointing to the keyword E4, and the correlation information R5 is the keyword E1 pointing to the keyword E5.

In this embodiment, the storage 11 also stores a to-be-verified article 12. In some embodiments, the information verification apparatus 1 may receive the to-be-verified article 12 through a transmission interface 15 and then store the to-be-verified article 12 in the storage 11. The aforesaid transmission interface 15 may be electrically connected to the processor 13 and may be connected to a network or hardware in a wired or wireless way for transceiving signals and receiving data.

The processor 13 executes a knowledge graph engine 10 and generates a to-be-verified knowledge graph KG2 of the to-be-verified article 12 by the knowledge graph engine 10 according to the to-be-verified article 12. Similarly, the to-be-verified knowledge graph KG2 includes a plurality of keywords and a plurality of pieces of correlation information between the keywords. Please refer to a specific example shown in FIG. 1C for better understanding, which, however, is not intended to limit the scope of the present invention. In the specific example shown in FIG. 1C, the to-be-verified knowledge graph KG2 includes four keywords E1, E2, E3, E6 and four pieces of directional correlation information R1, R2, R3, R6, wherein the correlation information R1 is the keyword E1 pointing to the keyword E2, the correlation information R2 is the keyword E1 pointing to the keyword E3, the correlation information R3 is the keyword E2 pointing to the keyword E3, and the correlation information R6 is the keyword E1 pointing to the keyword E6.

Next, the processor 13 generates a verified result (not shown) of the to-be-verified article 12 by comparing the to-be-verified knowledge graph KG2 with the reference knowledge graph KG1. In some embodiments, the processor 13 determines whether the to-be-verified knowledge graph KG2 has at least one outlier by comparing the to-be-verified knowledge graph KG2 with the reference knowledge graph KG1. If the processor 13 finds out one or more outliers in the to-be-verified knowledge graph KG2 after comparing the to-be-verified knowledge graph KG2 with the reference knowledge graph KG1, the verified result of the to-be-verified article 12 is that the to-be-verified article 12 has one or more pieces of information needed to be confirmed. The correctness of the information needed to be confirmed may be confirmed by a personnel (e.g., a user) or some verification systems or methods. It shall be appreciated that each outlier corresponds to two keywords and the piece of correlation information between the two keywords, and the two keywords and the correlation information between the two keywords are the information needed to be confirmed. If the processor 13 does not find out an outlier in the to-be-verified knowledge graph KG2 after comparing the to-be-verified knowledge graph KG2 with the reference knowledge graph KG1, the verified result of the to-be-verified article 12 is that the content of the to-be-verified article 12 is correct. That is, further confirmation by a user is not required.

Taking the reference knowledge graph KG1 shown in FIG. 1B and the to-be-verified knowledge graph KG2 shown in FIG. 1C as an example, the processor 13 finds out that the keyword E6 in the to-be-verified knowledge graph KG2 is an outlier after comparing the to-be-verified knowledge graph KG2 with the reference knowledge graph KG1. Since the keyword E6 is an outlier, the information needed to be confirmed includes the keyword E6 (i.e., the outlier itself) and the correlation information R6 between the keyword E1 and the keyword E6 (i.e., the correlation information between the keyword E1 and the outlier).

In some embodiments, the processor 13 may generate the verified result of the to-be-verified article 12 in another way. Specifically, the processor 13 reduces the dimension of the reference knowledge graph KG1 into a reference dataset RD1 by a dimension reduction algorithm (e.g., a graph embedding algorithm, a network embeddings algorithm, a network representation algorithm, or the like, without being limited thereto) and reduces the dimension of the to-be-verified knowledge graph KG2 into a to-be-verified dataset RD2 by the same dimension reduction algorithm. In some embodiments, the keywords and the correlation information in the reference knowledge graph KG1 and the to-be-verified knowledge graph KG2 may be individually reduced into a two-dimensional vector space, and the reference dataset RD1 and the to-be-verified dataset RD2 are individually represented by two-dimensional coordinates, wherein each of the reference dataset RD1 and the to-be-verified sets RD2 comprises a plurality of points. Thereafter, the processor 13 generates the verified result of the to-be-verified article 12 by comparing the to-be-verified dataset RD2 with the reference dataset RD1.

For example, if the processor 13 finds out that one or more points in the to-be-verified datum RD2 do not have corresponding points in the reference datum RD1 (i.e., no point located in the same or similar position in the reference datum RD1) after comparing the points in the to-be-verified datum RD2 with the points in the reference datum RD1, the verified result of the to-be-verified article 12 is that one or more pieces of information of the to-be-verified article 12 needed to be confirmed. Similarly, each point that does not have a corresponding point in the reference datum RD1 corresponds to two keywords in the to-be-verified knowledge graph KG2 and the correlation information between the two keywords, and the two keywords and the correlation information between the two keywords are the information needed to be confirmed. If the processor 13 determines that each point in the to-be-verified datum RD2 has a corresponding point in the reference datum RD1 after comparing the to-be-verified datum RD2 with the reference datum RD1, the verified result of the to-be-verified article 12 is that the content of the to-be-verified article 12 is correct and further confirmation by a user is not required.

Please refer to the specific examples shown in FIG. 1D and FIG. 1E for better understanding, which, however, are not intended to limit the scope of the present invention. FIG. 1D depicts a schematic view of the reference dataset RD1 obtained after performing dimension reduction on the reference knowledge graph KG1 shown in FIG. 1B, wherein the dots E1′, E2′, E3′, E4′, and E5′ respectively correspond to the keywords E1, E2, E3, E4, and E5 in the reference knowledge graph KG1. The two-dimensional coordinates of the dots E1′, E2′, E3′, E4′, and E5′ in FIG. 1D are used to represent the relative positions of the keywords E1, E2, E3, E4, and E5 and the correlation information therebetween of the reference knowledge graph KG1 in the two-dimensional vector space after the dimension reduction. FIG. 1E depicts a schematic view of the to-be-verified datum RD2 obtained after performing dimension reduction on the to-be verified knowledge graph KG2 shown in FIG. 1C, wherein the dots E1′, E2′, E3,′ and E6′ respectively correspond to the keywords E1, E2, E3, and E6 in the to-be verified knowledge graph KG2. The two-dimensional coordinates of the dots E1′, E2′, E3′, and E6′ in FIG. 1E are used to represent the relative positions of the keywords E1, E2, E3, and E6 and the correlation information therebetween of the to-be-verified knowledge graph KG2 in the two-dimensional vector space after the dimension reduction.

The processor 13 compares the two-dimensional coordinate values of the points in the to-be-verified datum RD2 with those in the reference datum RD1 and finds out that the dot E6′ has no corresponding dot in FIG. 1D. Since the processor 13 finds out that the dot E6′ in the to-be-verified datum RD2 has no corresponding dot in FIG. 1D (i.e., no dot in FIG. 1D has the same or similar coordinates as that of the dot E6′), it can be inferred that the keyword E6 corresponding to the dot E6′, the correlation information R6, and the keyword E1 form an outlier. It means that the keyword E6 and the correlation information R6 between the keyword E6 and the keyword E1 may be abnormal.

In some embodiments, after the processor 13 generates the verified result of the to-be-verified article 12, the verified result may be provided to the user for reference. The way that the information verification apparatus 1 provides the verified result to the user is not limited in the present invention. For example, if the information verification apparatus 1 comprises a transmission interface 15, the verified result of the to-be-verified article 12 may be transmitted by the transmission interface 15. As another example, if the information verification apparatus 1 further comprises a display screen 17, the verified result may be displayed on the display screen 17. The aforesaid display screen 17 is electrically connected to the processor 13 and may be a liquid crystal display (LCD), an organic light emitting diode (OLED) screen, an electronic paper screen, or any other apparatus capable of displaying digital information.

In some embodiments, if the verified result of the to-be-verified article 12 is that the to-be-verified article 12 has a piece of to-be-confirmed information and the to-be-confirmed information is confirmed to be correct information by the user, the processor 13 may further update the reference knowledge graph KG1 with the to-be-confirmed information that has been confirmed. Specifically, since the to-be-confirmed information is the two keywords corresponding to an outlier and the correlation information between the two keywords, the processor 13 may add the two keywords corresponding to the outlier and the correlation information between the two keywords into the original reference knowledge graph KG1 to update the reference knowledge graph KG1.

In this embodiment, the reference knowledge graph KG1 stored in the storage 11 at the initial stage may be generated by the knowledge graph engine 10 by searching and labeling a plurality of related articles according to a plurality of reference articles 14a, . . . , 14z that have been labeled. All the reference articles 14a, . . . , 14z have been confirmed by the user that their contents are correct. In some embodiments, the reference articles 14a, . . . , 14z may be stored in the storage 11 in advance. In some embodiments, the information verification apparatus 1 receives the reference articles 14a, . . . , 14z via the transmission interface 15 and then stores the reference articles 14a, . . . , 14z in the storage 11. Several ways for generating the reference knowledge graph KG1 will be described in detail below.

In some embodiments, the processor 13 obtains a plurality keywords of each of the reference articles 14a, . . . , 14z by applying a word segmentation process (not shown) and a Term Frequency-Inverse Document Frequency (TF-IDF) algorithm (not shown) to each of the reference articles 14a, . . . , 14z. In addition, the information verification apparatus 1 successively displays each of the reference articles 14a, . . . , 14z and the keywords thereof on the display screen 17 so that the user may label the correlation information thereof through an input interface. Please refer to a specific example shown in FIG. 1F for better understanding, which, however, is not intended to limit the scope of the present invention. In FIG. 1F, the reference article 14a and the keywords E1, E2, E3, E4, and E5 in the reference article 14a are shown. The user may label the correlation information between the keywords through an input interface (e.g. clicking by a mouse, directly touching the display screen 17). In the specific example shown in FIG. 1F, the user labels the directional correlation information R1 and R3 in the reference article 14a, wherein the correlation information R1 is the keyword E1 pointing to the keyword E2 and the correlation information R3 is the keyword E2 pointing to the keyword E3.

In some embodiments, the processor 13 does not apply the word segmentation process and the TF-IDF algorithm to each of the reference articles 14a, . . . , 14z. In these embodiments, the information verification apparatus 1 sequentially displays each of the reference articles 14a, . . . , 14d (i.e. a small portion of the reference articles 14a, . . . , 14z) on the display screen 17 for the user to directly label the keywords and at least one piece of correlation information between the keywords for each of the reference articles 14a, . . . , 14d.

In order to reduce the number of labeling made by the user through the input interface and to establish the reference knowledge graph KG1 more quickly, the knowledge graph engine 10 in some embodiments may perform additional operations. Specifically, after each of the reference articles 14a, . . . , 14d is labeled with a plurality of keywords and at least one piece of correlation information, the knowledge graph engine 10 generates a plurality of triplet messages (not shown) according to the correlation information of the reference articles 14a, . . . , 14d. Taking the reference article 14a shown in FIG. 1F as an example, the knowledge graph engine 10 generates two triplet messages, wherein one triplet message comprises the keyword E1, the correlation information R1, and the keyword E2 and the other triplet message comprises the keyword E2, the correlation information R3, and the keyword E3. After the knowledge graph engine 10 generates the triplet messages of all the reference articles 14a, . . . , 14d, the knowledge graph engine 10 establishes the reference knowledge graph KG1 according to the triplet messages. For example, the knowledge graph engine 10 may integrate the keywords and the correlation information corresponding to the triplet messages into a graph as the reference knowledge graph KG1.

Since the amount of the reference articles 14a, . . . , 14d is not much, the knowledge graph engine 10 has to perform additional operations in order to establish a complete reference knowledge graph KG1. Specifically, the knowledge graph engine 10 has an automatic labeling function, which can find out a plurality of similar sentences from a database (not shown) according to the triplet messages and automatically perform labeling to derive expanded triplet messages (not shown). For example, the knowledge graph engine 10 may use the Elasticsearch search engine to conduct full-text search on a plurality of articles in a database and thereby find out the similar sentences. The knowledge graph engine 10 further automatically labels two keywords and a piece of correlation information between the two keywords for each of the similar sentences. It shall be noted that each of the keywords labeled by the knowledge graph engine 10 for the similar sentences is the same as or similar to the keyword in some triplet message (for example, the keyword “lung cancer” is similar to the keyword “cancer”). By labeling the similar sentences with keywords and correlation information, the knowledge graph engine 10 generates a plurality of expanded triplet messages (not shown). Next, the knowledge graph engine 10 updates the reference knowledge graph KG1 according to the expanded triplet message.

In some embodiments, the processor 13 may further establish or update a disambiguation database (not shown) based on the triplet messages and the expanded triplet messages. The disambiguation database records which keywords are similar or synonymous and stores a plurality of disambiguated sentences (not shown) obtained by disambiguation processing. In these embodiments, the processor 13 may train a neural network model using the disambiguated sentences, the processor 13 may further apply the disambiguation process to the reference articles 14a, . . . , 14d according to the neural network model, and then the knowledge graph engine 10 may further create or update the reference knowledge graph KG1 accordingly.

According to the above description, the information verification apparatus 1 verifies whether the to-be-verified article 12 has information needed to be confirmed by comparing the to-be-verified knowledge graph KG2 of the to-be-verified article 12 with the reference knowledge graph KG1. Since a knowledge graph (e.g., the reference knowledge graph KG1, the to-be-verified knowledge graph KG2) contains a plurality of keywords and correlation information between the keywords, the information verification apparatus 1 can find out not only abnormal keywords but also abnormal correlation information. Hence, the information verification apparatus 1 does not have the defects that the prior art has. In addition, the information verification apparatus 1 may generate triplet messages by labeling reference articles, find out a plurality of similar sentences by using the triplet messages, and generate a plurality of expanded triplet messages by using the similar sentences, and then create or update the reference knowledge graph KG1 accordingly. With a more complete reference knowledge graph KG1, the verified result of the to-be-verified article determined by the information verification apparatus 1 will be more accurate.

A second embodiment of the present invention is a method for verification of information (hereinafter referred to as “information verification method”), and a main flowchart thereof is depicted in FIG. 2A. The information verification method is adapted for use in an electronic computing apparatus, e.g., the apparatus 1 for verification of information according to the first embodiment.

The information verification method comprises at least steps S201 and S203. In the step S201, the electronic computing apparatus generates a to-be-verified knowledge graph of a to-be-verified article by a knowledge graph engine. In step S203, the electronic computing apparatus generates a verified result of the to-be-verified article by comparing the to-be-verified knowledge graph with a reference knowledge graph. It shall be noted that, the knowledge graph engine may generate the reference knowledge graph by searching and labeling a plurality of related articles according to a plurality of reference articles that have been labeled.

In some embodiments, the step S203 may comprise a step for determining, by the electronic computing apparatus, whether there is an outlier in the to-be-verified knowledge graph by comparing the to-be-verified knowledge graph with the reference knowledge graph. If an outlier is found out in the to-be-verified knowledge graph, it means that the to-be-verified article has one piece of information needed to be confirmed. The information needed to be confirmed may be provided by a display interface to some personnel (e.g., users) or further verification systems or methods to confirm the correctness thereof. If no outlier is found out in the to-be-verified knowledge graph, it means that the to-be-verified article does not have information needed to be confirmed. In some embodiments, if the information to be confirmed corresponding to the outlier is confirmed to be correct information by the user, the information verification method may further executes a step for updating the reference knowledge graph by the electronic computing apparatus according to the two keywords and the correlation information between the two key words that correspond to the outlier.

In some embodiments, the main flowchart of the information verification method is as shown in FIG. 2B. In these embodiments, the information verification method also performs step S201 first. Next, in step S213, the electronic computing apparatus reduces the dimension of the to-be-verified knowledge graph into a to-be-verified dataset. In step S215, the electronic computing apparatus reduces the dimension of a reference knowledge graph into a reference dataset. In some embodiments, the step S213 may reduce the dimension of each keyword and correlation information in the to-be-verified knowledge graph into a two-dimensional vector space and represent the to-be-verified dataset by two-dimensional coordinates, wherein the to-be-verified dataset comprises a plurality of points. The step S215 may reduce the dimension of each keyword and correlation information in the reference knowledge graph into a two-dimensional vector space and represent the reference dataset by two-dimensional coordinates, wherein the reference dataset comprises a plurality of points. It shall be noted that, in some embodiments, the step S215 may be performed earlier than the step S213 or even earlier than the step S201, which may be adjusted according to actual operation requirements. Then, in step S217, the electronic computing apparatus generates a verified result of the to-be-verified article by comparing the to-be-verified dataset with the reference dataset.

In some embodiments, the step S217 may comprise a step for determining, by the electronic computing apparatus, whether the to-be-verified knowledge graph has an outlier by comparing the to-be-verified datum with the reference datum. If an outlier is found in the to-be-verified knowledge graph, it means that the to-be-verified article has information needed to be confirmed. If no outlier is found in the to-be-verified knowledge graph, it means that the to-be-verified article does not have information needed to be confirmed. In some embodiments, if the information needed to be confirmed corresponding to the outlier is confirmed to be correct information by the user, the information verification method may further execute step S219. In the step S219, the electronic computing apparatus updates the reference knowledge graph by adding the two keywords and the correlation information between the two keywords corresponding to the outlier into the original reference knowledge graph.

In some embodiments, the information verification method may further perform the process flow shown in FIG. 2C by the electronic computing apparatus to establish a reference knowledge graph or even update the reference knowledge graph.

In these embodiments, the electronic computing apparatus stores a plurality of reference articles, wherein each of the reference articles has a plurality of keywords and is defined with at least one piece of correlation information, and each of the at least one piece of correlation information individually corresponds to two of the keywords. For example, the information verification method may obtain the keywords of each of the reference articles by applying a word segmentation process and a TF-IDF algorithm to each of the reference articles. Moreover, the information verification method may also display each of the reference articles by a display interface for a user to label each of the reference articles. By doing so, keywords and correlation information thereof in each of the reference articles are labeled. Thereafter, in step S221, the knowledge graph engine generates a plurality of triplet messages according to the correlation information of the reference articles. In step S223, the knowledge graph engine establishes the reference knowledge graph according to the triplet messages.

Steps S225, S227, and S229 are for updating the reference knowledge graph. In the step S225, the knowledge graph engine finds out a plurality of similar sentences from a database according to the triplet messages. In the step S227, the knowledge graph engine automatically labels two keywords and a piece of correlation information between the two keywords for each of the similar sentences and thereby generate a plurality of expanded triplet messages. In the step S229, the knowledge graph engine updates the reference knowledge graph according to the expanded triplet messages.

In some embodiments, the information verification method may further perform a step by the electronic computing apparatus for establishing a disambiguation database according to the triplets and the expanded triplet messages. The disambiguation database records which keywords are similar or synonymous and stores a plurality of disambiguated sentences obtained by applying disambiguation processing. In these embodiments, the information verification method may further perform a step by the electronic computing apparatus for training a neural network model using the disambiguated sentences and creating or updating the reference knowledge graph by the knowledge graph engine after the disambiguation processing.

In addition to the aforesaid steps, the second embodiment can also execute all the operations and steps of the information verification apparatus 1 set forth in the first embodiment, have the same functions, and deliver the same technical effects as the first embodiment. How the second embodiment executes these operations and steps, have the same functions, and deliver the same technical effects as the first embodiment will be readily appreciated by those of ordinary skill in the art based on the explanation of the first embodiment, and thus will not be further described herein.

The technology (at least including the apparatus and method) for verification of information provided by the present invention verifies whether a to-be-verified article has information needed to be confirmed by comparing a to-be-verified knowledge graph of the to-be-verified article with a reference knowledge graph. Since a knowledge graph contains a plurality of keywords and correlation information between the keywords, the technology for verification of information provided by the present invention can find out not only abnormal keywords but also abnormal correlation information. Thereby, the technology for verification of information provided by the present invention does not have the defects that the prior art has. In addition, the technology for verification of information provided by the present invention may also generate triplet messages by labeling reference articles, find out a plurality of similar sentences by using the triplet messages, and generate a plurality of expanded triplet messages by using the similar sentences. In this way, the reference knowledge graph can be updated. By updating the reference knowledge graph, the verified result of the to-be-verified article determined by the technology for verification of information provided by the present invention will be more accurate.

The above disclosure is related to the detailed technical contents and inventive features thereof. A person having ordinary skill in the art may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. An apparatus for verification of information, comprising:
a storage, being configured to store a reference knowledge graph; and
a processor, being electrically connected to the storage, wherein the processor generates a to-be-verified knowledge graph of a to-be-verified article by a knowledge graph engine and generates a verified result of the to-be-verified article by comparing the to-be-verified knowledge graph with the reference knowledge graph,
wherein the knowledge graph engine may generate the reference knowledge graph by searching and labeling a plurality of related articles according to a plurality of reference articles that have been labeled.

2. The apparatus for verification of information of claim 1, wherein each of the reference articles has a plurality of keywords and is defined with at least one piece of correlation information, each of the at least one piece of correlation information individually corresponds to two of the keywords, and the knowledge graph engine further generates a plurality of triplet messages according to the correlation information of the reference articles and establishes the reference knowledge graph according to the triplet messages.

3. The apparatus for verification of information of claim 2, wherein the knowledge graph engine finds out a plurality of similar sentences from a database according to the triplet messages, the knowledge graph engine further automatically labels two keywords and a piece of correlation information between the two keywords for each of the similar sentences and thereby generates a plurality of expanded triplet messages, and the knowledge graph engine further updates the reference knowledge graph according to the expanded triplet messages.

4. The apparatus for verification of information of claim 1, wherein the processor finds out an outlier in the to-be-verified knowledge graph by comparing the to-be-verified knowledge graph with the reference knowledge graph, and the processor further determines that the verified result is that the to-be-verified article needed to be confirmed based on the result of finding out the outlier.

5. The apparatus for verification of information of claim 4, wherein the outlier corresponds to two keywords and a piece of correlation information between the two keywords, and the processor further updates the reference knowledge graph according to the two keywords and the correlation information.

6. The apparatus for verification of information of claim 2, further comprising:
a display screen, being electrically connected to the processor and configured to display each of the reference articles for a user to label each of the reference articles.

7. The apparatus for verification of information of claim 2, wherein the processor obtains the keywords of each of the reference articles by applying a word segmentation process and a Term Frequency-Inverse Document Frequency (TF-IDF) algorithm to each of the reference articles.

8. The apparatus for verification of information of claim 3, wherein the processor further establishes a disambiguation database according to the triplet messages and the expanded triplet messages.

9. The apparatus for verification of information of claim 8, wherein the disambiguation database is configured to store a plurality of disambiguated sentences obtained by applying disambiguation process, and the processor uses the disambiguated sentences to train a neural network model as the knowledge graph engine.

10. An apparatus for verification of information, comprising:
a storage, being configured to store a reference knowledge graph; and
a processor, being electrically connected to the storage and configured to generate a to-be-verified knowledge graph of a to-be-verified article by a knowledge graph engine, reduce the dimension of the to-be-verified knowledge graph into a to-be-verified dataset, reduce the dimension of the reference knowledge graph into a reference dataset, and generate a verified result of the to-be-verified article by comparing the to-be-verified dataset with the reference dataset.

11. A method for verification of information, being adapted for use in an electronic computing device, and the method for verification of information comprising:
generating a to-be-verified knowledge graph of a to-be-verified article by a knowledge graph engine; and
generating a verified result of the to-be-verified article by comparing the to-be-verified knowledge graph with a reference knowledge graph,
wherein the knowledge graph engine may generate the reference knowledge graph by searching and labeling a plurality of related articles according to a plurality of reference articles that have been labeled.

12. The method for verification of information of claim 11, wherein each of the reference articles has a plurality of keywords and is defined with at least one piece of correlation information, each of the at least one piece of correlation information individually corresponds to two of the keywords, and the method for verification of information further comprises:
generating a plurality of triplet messages according to the correlation information of the reference articles by the knowledge graph engine; and
establishing the reference knowledge graph according to the triplet messages by the knowledge graph engine.

13. The method for verification of information of claim 12, further comprising:
finding out a plurality of similar sentences from a database according to the triplet messages by the knowledge graph engine;
labeling two keywords and a piece of correlation information between the two keywords for each of the similar sentences by the knowledge graph engine automatically and thereby generating a plurality of expanded triplet messages; and
updating the reference knowledge graph by the knowledge graph engine according to the expanded triplet messages.

14. The method for verification of information of claim 11, wherein the step of generating the verified result comprises:
finding out an outlier in the to-be-verified knowledge graph by comparing the to-be-verified knowledge graph and the reference knowledge graph; and
determining that the verified result is that the to-be-verified article needed to be confirmed based on the result of finding out the outlier.

15. The method for verification of information of claim 14, wherein the outlier corresponds to two keywords and a piece of correlation information between the two keywords, and the method for verification of information further comprises:
updating the reference knowledge graph by the knowledge graph engine according to the two keywords and the correlation information.

16. The method for verification of information of claim 12, further comprising:
displaying each of the reference articles for a user to label each of the reference articles.

17. The method for verification of information of claim 12, further comprising:
obtaining the keywords of each of the reference articles by applying a word segmentation process and a TF-IDF algorithm to each of the reference articles.

18. The method for verification of information of claim 13, further comprising:
establishing a disambiguation database according to the triplet messages and the expanded triplet messages.

19. The method for verification of information of claim 18, wherein the disambiguation database is configured to store a plurality of disambiguated sentences obtained by applying disambiguation process, and the method for verification of information further comprises:
using the disambiguated sentences to train a neural network model as the knowledge graph engine.

20. A method for verification of information, being adapted for use in an electronic computing apparatus, and the method for verification of information comprising:
generating a to-be-verified knowledge graph of a to-be-verified article by a knowledge graph engine;
reducing the dimension of the to-be-verified knowledge graph into a to-be-verified dataset;
reducing the dimension of a reference knowledge graph into a reference dataset; and
generating a verified result of the to-be-verified article by comparing the to-be-verified dataset with the reference dataset.
